(19) United States
(12) Patent Application Publication
(10) Pub. No.: US 2008/0250152 A1
(43) Pub. Date: Oct. 9, 2008

(54) COMMUNICATION METHOD HAVING FIREWALL NETWORK TUNNEL AND LOCATION TRANSPARENCY

(76) Inventor: CHING-HUNG CHOU, Taipei (TW)

Correspondence Address: G. LINK CO., LTD., 3550 BELL ROAD, MINOOKA, IL, 60447, US

(21) Appl. No.: 11/696,180

(22) Filed: Apr. 3, 2007

(51) Int. Cl. G06F 15/16

(52) U.S. Cl. 709/230

(57) ABSTRACT

A communication method allowing data to be exchanged over different networks and having a firewall network tunnel and location transparency includes a first web application program, a first web server, a first cache, a first transport layer communication program, a plurality of second web application programs, a plurality of second web servers, a plurality of second caches, a plurality of second transport layer communication protocols, a plurality of Hyper Text Transfer Protocol (HTTP), a first communication packet, a plurality of HTTP second communication packets, a plurality of cache communication packets, and a plurality of transport layer communication packets, to achieve communication over different networks by executing certain steps.

### BACKGROUND OF THE INVENTION

1. Field of the Invention

This invention relates to communication methods, and more particularly, to a communication method allowing data to be exchanged over different networks and having a firewall network tunnel and location transparency.

2. Description of Related Art

In modern network communication, a remote web server is a target to which data are downloaded, and complies with hyper text transfer protocol (HTTP) or transmission control protocol/internet protocol (TCP/IP). However, such web communication architecture has to know the web location of each data source, and web jam happens all the time, because the majority of data are concentrated on only some of the web servers.

A peer to peer is another web communication architecture. Both parties can communicate with each other directly over user datagram protocol (UDP) or TCP and load data from a target who owns the data over the web. However, this architecture is affected by a firewall and has an unstable communication state. Further, this architecture has to function with a predetermined download program such as SKYPE.

### SUMMARY OF THE INVENTION

In views of the above-mentioned problems of the prior art, it is a primary objective of the present invention to provide a communication method, which has a firewall network tunnel and location transparency and allows data to be exchanged over different networks.

To achieve the above-mentioned and other objectives, the communication method having the firewall network tunnel and the location transparency uses an improved communication method having both the web server transport architecture and the peer to peer transport architecture. Set up a web server for each client end, whose web application program communicates with the client end only through HTTP. The web servers communicate with one another through peer to peer transport architecture including, but not limited to, TCP, UDP, UDP Hole Punching and UPnP. If communication fails due to the firewall, a remote web server transports an HTTP request (hereinafter “request”) to another remote web server which is not affected by the firewall, so as to achieve having a firewall network tunnel and allow the communication to be performed successfully. Each web server stores downloaded data according to the indications of an HTTP response header. Other web servers, when needing the same data, can acquire the data not only from an original data provider, but also by downloading from the web server which is stored with the data, so as to achieve the location transparency. The larger the number of users who download the same data is, the faster the speed of data-downloading becomes. Therefore, a data provider, even without a large web server, can still establish a large content delivery network.

In addition to the above two improved communication methods, the communication method, which has the firewall network tunnel and location transparency, of the present invention can append to HTTP an encryption function, such as hyper text transfer protocol over secure socket layer (SSL) (hereinafter “HTTPS”). A web application program can emit HTTP requests through the remote web server, to broadcast messages to remote web application programs and to overcome the drawback that world wide web (WWW) architecture is hardly to achieve a content push function.

### BRIEF DESCRIPTION OF DRAWINGS

The invention can be more fully understood by reading the following detailed description of the preferred embodiments, with reference made to the accompanying drawings, wherein:

FIG. 1 is a block diagram of a network architecture of the preferred embodiment according to the present invention; and

FIG. 2 is a network communication schematic diagram of the preferred embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

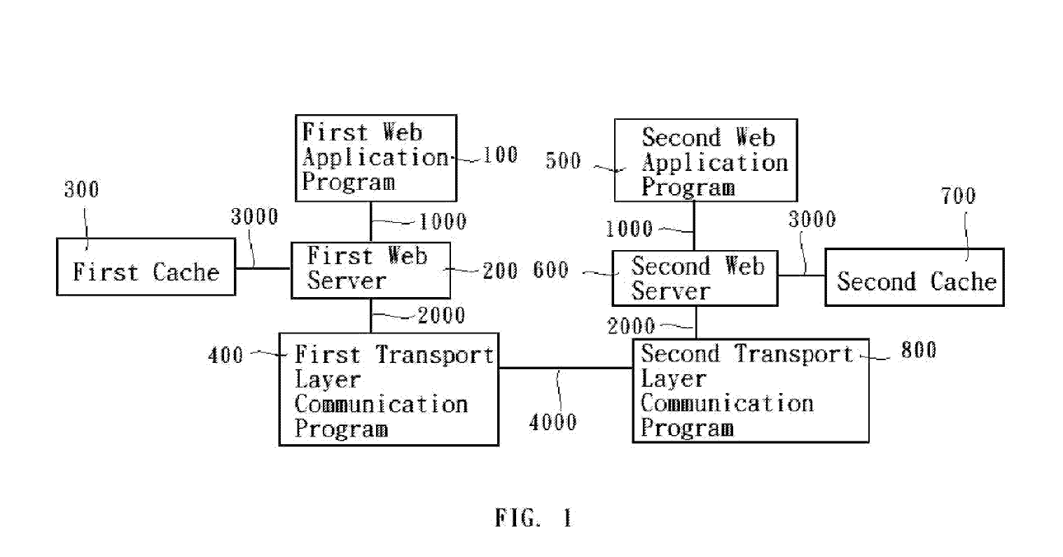

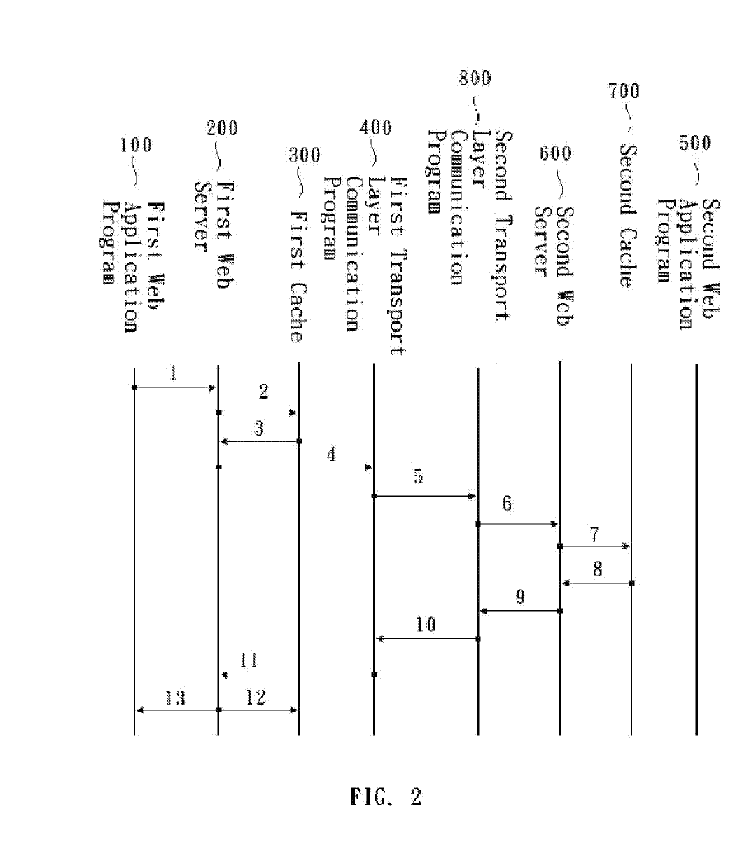

Please refer to FIG. 1 and FIG. 2, which are a block diagram of a network architecture and a network communication schematic diagram of the preferred embodiment according to the present invention respectively, and include a first web application program 100, a first web server 200, a first cache 300, a first transport layer communication program 400, a second web application program 500, a second web server 600, a second cache 700, a second transport layer communication protocol 800, an HTTP first communication packet 1000, an HTTP second communication packet 2000, a cache communication packet 3000 and a transport layer communication packet 4000.

The first web application program 100 has to executed the following steps to acquire data from a network:
step 1: transporting at least one HTTP firs communication packet 100 of “Ajax request” to the first web server 200 with the first web application program 100, which is designed based on “HTML” and “JavaScript”;
step 2: the first web server 200 determining whether it can process according to a request Uniform Resource Locator (request URL) of step 1, and the first web server 200 transporting at least one cache communication packet 300 to the first cache 300 to search whether the first cache 300 owns the data if the first web server 200 determines that it cannot process, or proceeding to step 13;
step 3: the first cache 300 transporting at least one cache communication packet 3000 to the first web server 200; step 4: executing step 13 if the first web server 200, after the cache communication packet 3000 received in step 3, can process the HTTP first communication packet 1000 of step 1, or the first web server 200 transporting at least one HTTP second communication packet 2000 to the first transport layer communication protocol 400;
step 5: the first transport layer communication protocol 400 transporting the transport layer communication packet 4000 of at least one UDP to the second transport layer communication protocol 800;
step 6: the second transport layer communication protocol 800 transporting at least one HTTP second communication packet 2000 to the second web server 600 not affected by the firewall and having data;
step 7: the second web server 600 transporting at least one cache communication packet 3000 to the second cache 700;
step 8: the second cache 700 transporting at least one cache communication packet 3000 having needed data to the second web server 600;
step 9: the second web server 600 transporting at least one HTTP second communication packet 2000 having needed data to the second transport layer communication protocol 800;
step 10: the second transport layer communication protocol 800 transporting at least one transport layer communication packet 4000 having needed data to the first transport layer communication protocol 400;
step 11: the first transport layer communication protocol 400 transporting at least one HTTP second communication packet 2000 having needed data to the first web server 200;
step 12: the first web server 200 transporting at least one cache communication packet 3000 having needed data to the first cache 300 as backup data; and
step 13: the first web server 200 transporting at least one HTTP first communication packet 1000 having needed data to the first web application program 100, for a user end to use the data.

The foregoing descriptions of the detailed embodiments are only illustrated to disclose the features and functions of the present invention and not restrictive to the scope of the present invention. It should be understood to those in the art that all modifications and variations according to the spirit and principle in the disclosure of the present invention should fall within the scope of the appended claims.

What is claimed is:

1. A communication method having a firewall network tunnel and location transparency, allowing data to be exchanged over different networks, the communication method comprising the following steps:
(A) having a first web application program to transport at least one HTTP first communication packet to a first web server;
(B) executing step (O) if the first web server can process the HTTP first communication packet in step (A);
(C) having the first web server to transport at least one cache communication packet to a first cache;
(D) having the first cache to transport at least one cache communication packet to the first web server;
(E) executing step (O) if the first web server, after receiving the cache communication packet in step (D), can process the HTTP communication packet in step (A);
(F) having the first web server to transport at least one HTTP second communication packet to a first transport layer communication program;
(G) having the first transport layer communication protocol to transport at least one transport layer communication packet to a second transport layer communication protocol;
(H) having the second transport layer communication protocol to transport at least one HTTP second communication packet to a second web server;
(I) having the second web server to transport at least one cache communication packet to a second cache;
(J) having the second cache to transport a cache communication packet to the second web server;
(K) having the second network to transport at least one HTTP second communication packet to the second transport layer communication protocol;
(L) having the second transport communication protocol to transport at least one transport layer communication packet to the first transport layer communication protocol;
(M) having the first transport layer communication protocol to transport at least one HTTP second communication packet to the first web server;
(N) having the first web server to transport at least one cache communication packet to the first cache; and
(O) having the first web server to transport at least one HTTP first communication packet to the first web application program.

2. The communication method of claim 1, wherein the transport layer communication packet is a TCP packet, a UDP packet, a UDP hole punching packet or a universal plug-n-play (UPnP) packet,

3. The communication method of claim 1, wherein the HTTP first communication packet and the HTTP second communication packet become an HTTPS communication packet by appending encryption function.
